(19) United States
(12) Patent Application Publication
(10) Pub. No.: US 2004/0150897 A1
(43) Pub. Date: Aug. 5, 2004

(54) Reading companion

(76) Inventor: Tyrone Smith, Greensboro, NC (US)

Correspondence Address: Tyrone Smith, 2 Glendale Oaks Court, Greensboro, NC, 27406, US

(21) Appl. No.: 10/356,772

(22) Filed: Feb. 3, 2003

(51) Int. Cl. G02B 27/02

(52) U.S. Cl. 359/803

(57) ABSTRACT

The reading companion is an apparatus designed to allow individuals to read more quickly while also ensuring they have clearer retention and understanding of the book, magazine, or other reading material. The reading companion consist of an elongated rod, extending from one end of this reading tool is a base that features a flat head through which it could easily be grasped in his or her left or right hand Next, it would be placed beneath A word or sentence within the book, magazine, or other reading material. The words or sentence could quickly be read, and this tool would be moved beneath the next word or sentence within the book. The reading companion will ensure that reading material was easily comprehended without words or sentences being skipped.

### SUMMARY OF THE INVENTION

The Reading Companion is an apparatus used to help guide a reader as he reads.

The Reading Companion has several attachments such as the highlighter and the magnifier that can be used with the basic reading companion.

### BRIEF DESCRIPTION OF THE DRAWINGS

Referring now to the drawings:

FIG. 1 is a front view of the reading companion.

FIG. 2 is a side view of the reading companion.

FIG. 3 is a bottom view of the reading companion.

FIG. 4 is a perspective view of the reading companion.

FIG. 5 is a front view of the reading companion with a felt tip highlighter with cap attached.

FIG. 6 is a side view of the reading companion with a felt tip highlighter with cap attached.

FIG. 7 is a bottom view of the reading companion with a felt tip highlighter with cap attached.

FIG. 8 is a exploded view of the reading companion with cap off.

FIG. 9 is a revolved view of cap.

FIG. 10 is a view showing felt tip removed from reading companion.

FIG. 11 is a front view of reading companion with magnifier lens.

FIG. 12 is a side view of reading companion with magnifier lens.

FIG. 13 is a bottom view of reading companion with magnifier lens.

FIG. 14 is a front view of magnifier unattached to the reading companion.

FIG. 15 is a perspective view of reading companion with magnifier lens.

FIG. 16 is a front view of the reading companion with felt tip highlighter and magnifier lens.

FIG. 17 is a side view of the reading companion with felt tip highlighter and magnifier lens.

FIG. 18 is a bottom view of the reading companion with felt tip highlighter and magnifier lens.

FIG. 19 is a front view of the magnifier lens unattached to the reading companion.

FIG. 20 is a exploded view of the reading companion with felt tip highlighter and magnifier lens.

FIG. 21 is a revolved view of cap for felt tip highlighter.

FIG. 22 is a perspective view of the felt tip removed from the highlighter.

### DETAILED DESCRIPTION OF THE DRAWINGS

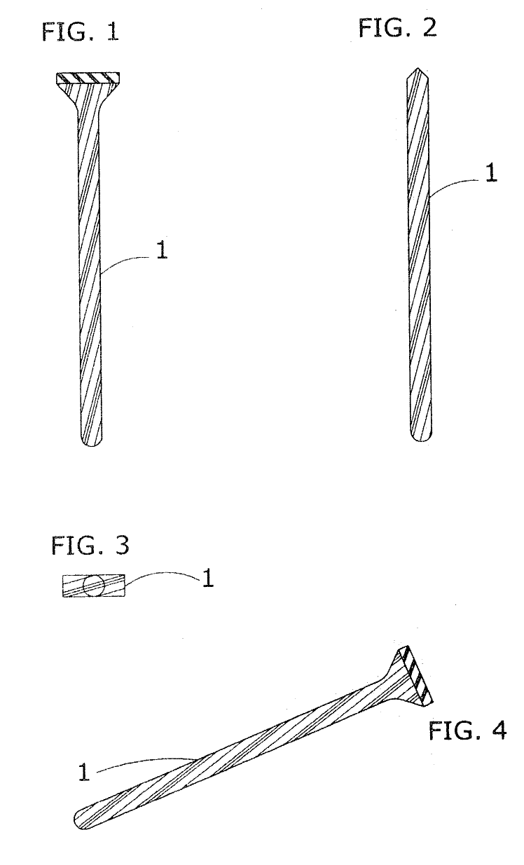

Referring to FIG. 1 which shows front view of the reading companion (1).

This device will be used to guide the reader as he reads.

FIG. 2 shows the side view (1) of the reading companion.

FIG. 3 shows the bottom view (1) of the reading companion.

FIG. 4 shows the perspective view (1) of the reading companion.

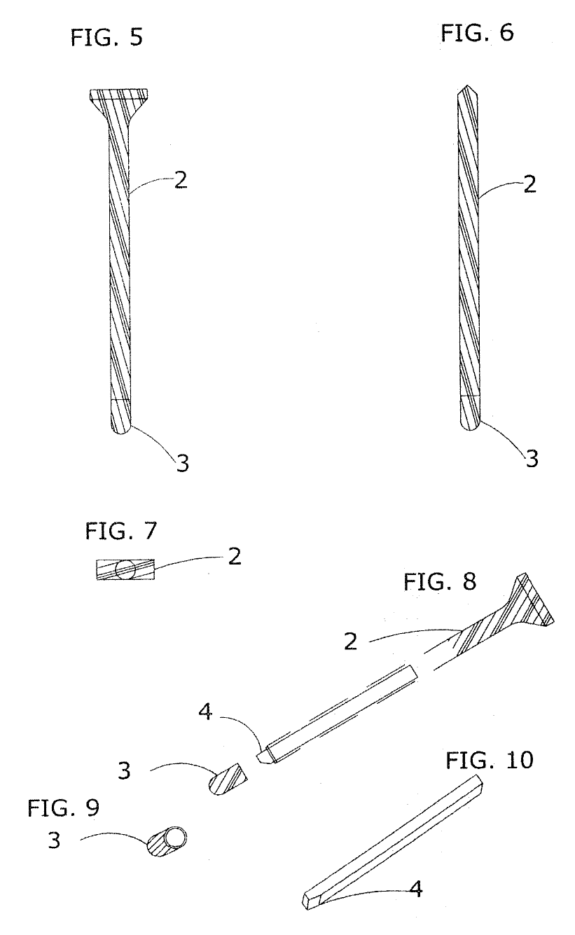

FIG. 5 shows the front view of the reading companion with felt-tip highlighter (2) with cap (3) attached.

FIG. 6 shows side view of the reading companion with felt-tip highlighter (2) with cap (3) attached.

FIG. 7 shows the bottom view of the reading companion (2).

FIG. 8 shows exploded view (2) of reading companion with felt tip highlighter (4) and cap unattached (3).

FIG. 9 shows revolved view (3) of cap.

FIG. 10 shows felt tip (4) removed from the reading companion.

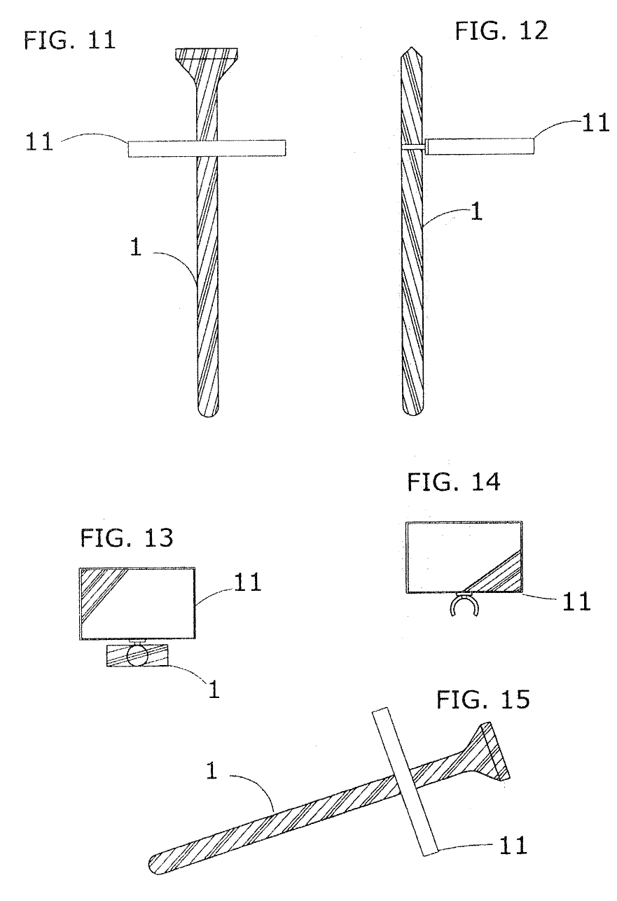

FIG. 11 shows front view (1) of the reading companion with magnifier lens (11) attached.

FIG. 12 shows side view (1) of the reading companion with magnifier lens (11) attached.

FIG. 13 shows bottom view (1) of the reading companion with magnifier lens (11) attached.

FIG. 14 shows front view of magnifier lens (11) unattached to the reader companion.

FIG. 15 shows perspective view (1) of reading companion with magnifier lens (11) attached.

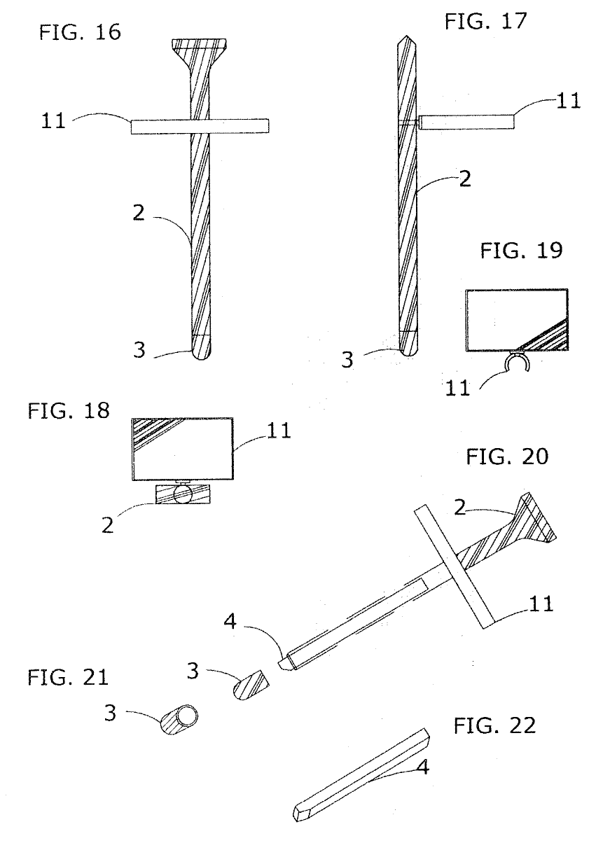

FIG. 16 shows front view (2) of the reading companion with felt tip highlighter (4) with magnifier lens (11) with cap (3) attached.

FIG. 17 shows side view (2) of reading companion with felt tip highlighter (4) with magnifier lens (11) and highlighter cap (3) attached.

FIG. 18 shows bottom view of the reading companion with highlighter and magnifier lens (11).

FIG. 19 shows front view of magnifier lens unattached.

FIG. 20 shows exploded view (2) of the reading companion with magnifier lens (11) and felt tip highlighter (4) and cap for highlighter (3).

FIG. 21 shows revolved view of cap for highlighter.

FIG. 22 shows perspective view of felt tip highlighter unattached.

### SUMMARY OF THE INVENTION

The Reading companion is an apparatus used to help guide a reader as he/she reads.

The Reading Companion has several attachments such as a highlighter and a magnifier that can be used with the basic reading companion.

### BRIEF DESCRIPTION OF THE DRAWINGS

Referring now to the drawings:

FIG. 1 is a front view of the reading companion.

FIG. 2 is a side view of the reading companion.

FIG. 3 is a bottom view of the reading companion.

FIG. 4 is a perspective view of the reading companion.

FIG. 5 is a front view of the reading companion with a felt tip highlighter with cap attached.

FIG. 6 is a side view of the reading companion with a felt tip highlighter with cap attached.

FIG. 7 is a bottom view of the reading companion with a felt tip highlighter with cap attached.

FIG. 8 is an exploded view of the reading companion with cap off.

FIG. 9 is a revolved view of cap.

FIG. 10 is a view showing felt tip removed from reading companion.

FIG. 11 is a front view of reading companion with magnifier lens.

FIG. 12 is a side view of reading companion with magnifier lens.

FIG. 13 is a bottom view of reading companion with magnifier lens.

FIG. 14 is a front view of magnifier unattached to the reading companion.

FIG. 15 is a perspective view of reading companion with magnifier lens.

FIG. 16 is a front view of the reading companion with felt tip highlighter and magnifier lens.

FIG. 17 is a side view of the reading companion with felt tip highlighter and magnifier lens.

FIG. 18 is a bottom view of the reading companion with felt tip highlighter and magnifier lens.

FIG. 19 is a front view of the magnifier lens unattached to the reading companion.

FIG. 20 is an exploded view of the reading companion with felt tip highlighter and magnifier lens.

FIG. 21 is a revolved view of cap for felt tip highlighter.

FIG. 22 is a perspective view of the felt tip removed from the highlighter.

### DETAILED DESCRIPTION OF THE DRAWINGS

FIG. 1 shows front view of the reading companion (1). This device will be used to guide the reader as they read.

FIG. 2 shows the side view (1) of the reading companion.

FIG. 3 shows the bottom view (1) of the reading companion.

FIG. 4 shows the perspective view (1) of the reading companion.

FIG. 5 shows the front view of the reading companion with felt-tip highlighter (2) with cap (3) attached.

FIG. 6 shows side view of the reading companion with felt-tip highlighter (2) with cap (3) attached.

FIG. 7 shows the bottom view of the reading companion (2).

FIG. 8 shows exploded view (2) of reading companion with felt tip highlighter (4) and cap unattached (3).

FIG. 9 shows revolved view (3) of cap.

FIG. 10 shows felt tip (4) removed from reading companion.

FIG. 11 shows front view (1) of the reading companion with magnifier lens (11) attached.

FIG. 12 shows side view (1) of the reading companion with magnifier lens (11) attached.

FIG. 13 shows bottom view (1) of the reading companion with magnifier lens (11) attached.

FIG. 14 shows front view of magnifier lens (11) unattached to the reading companion.

FIG. 15 shows perspective view (1) of reading companion with magnifier lens (11) attached.

FIG. 16 shows front view (2) of the reading companion with felt tip highlighter (4) with magnifier lens (11) with cap (3) attached.

FIG. 17 shows side view (2) of reading companion with felt tip highlighter (4) with magnifier lens (11) and highlighter cap (3) attached.

FIG. 18 shows bottom view of the reading companion with highlighter and magnifier lens (11).

FIG. 19 shows front view of magnifier lens unattached.

FIG. 20 shows exploded view (2) of the reading companion with magnifier lens (11) and felt tip highlighter (4) and cap for highlighter (3).

FIG. 21 shows revolved view of cap for highlighter.

FIG. 22 shows perspective view of fell tip highlighter unattached.

I claim:

1. This reading companion will enable the reader to read text in a fast and speedy manner.

2. This reading companion will enable the reader to highlight sentences using same said device.

3. This reading companion will enable the reader to stay focused on the line he is reading and enable him/her to comprehend more.

4. This reading companion will enable the reader to magnify text or footnotes using same said device.

5. This reading companion will help one to eliminate re-reading the same line.
